(19) United States
(12) Patent Application Publication
(10) Pub. No.: US 2009/0128365 A1
(43) Pub. Date: May 21, 2009

(54) METHODS AND SYSTEMS FOR DELIVERING REAL-TIME TRAFFIC VIDEO TO A HANDHELD DEVICE

(76) Inventor: Bruce Steven LASKIN, New York, NY (US)

Correspondence Address: CHOATE, HALL & STEWART LLP, TWO INTERNATIONAL PLACE, BOSTON, MA, 02110, US

(21) Appl. No.: 11/942,415

(22) Filed: Nov. 19, 2007

(51) Int. Cl. G08G 1/017

(52) U.S. Cl. 340/937

(57) ABSTRACT

A system and methods for viewing real time traffic video on a handheld device are shown and described. The method includes requesting by a handheld device, data from a remote traffic camera responsive to user input through a menu-driven interface of an application program. An appliance, residing in a traffic management center, creates coded image data representing a group of concatenated images by extracting selected frames from a video stream of the remote traffic camera and transmits the coded data to a host server. The handheld device receives the coded image data from the host server. The method also includes decoding the coded image data by the application program and displaying, on the handheld device, the group of concatenated images in repeated loops.

### FIELD OF THE INVENTION

The present disclosure relates to real time video transmission over a wireless network. In particular, the present disclosure relates to methods and systems for viewing real-time video of vehicular traffic on wireless handheld devices.

### BACKGROUND OF THE INVENTION

There exists a plurality of methods for obtaining real-time traffic information. Real-time traffic information can be obtained through television, internet or radio. Furthermore, traffic information can also be obtained using wireless handheld devices such as mobile phones, BLACKBERRY devices and PDA phones. These devices can be used to access a plurality of websites providing real-time traffic information.

Additionally, specific applications have also been developed to enable wireless handheld devices to access real-time traffic information. Some of these applications enable users to view animated video clips of traffic based on real time traffic information on their handheld devices.

However, these applications do not allow a user to see videos of actual traffic conditions on a handheld device. An application developed by Vizzion Inc. enables users to view images from cameras located at a plurality of remote locations. This application also does not allow the user to view videos of the actual traffic conditions which change very frequently.

### BRIEF SUMMARY OF THE INVENTION

In one aspect, a method for viewing real-time traffic video on a handheld device is shown and described. The method includes a handheld device requesting data from a remote traffic camera. A user of the handheld device makes the request through a menu-driven interface of an application program. An appliance, residing in a traffic management center, creates coded image data representing a group of concatenated images by extracting selected frames from a video stream of the remote traffic camera. The appliance transmits the coded data to a host server. The handheld device receives the coded data from the host server. The method also includes decoding the coded data by the application program and displaying, on the handheld device, the group of concatenated images in repeated loops.

In another aspect, a method of displaying real time traffic video on a handheld device includes a host server receiving coded image data representing a group of concatenated images. The group of images is created by an appliance residing in a traffic management center. The appliance creates the group by extracting selected frames from a remote traffic camera video stream. The method also includes the host server receiving a request for data from a remote traffic camera. A user of a handheld device makes the request through a menu driven interface of an application program. On receiving the request, the host server transmits the coded image data to the handheld device. The application program decodes the image data and displays the group of concatenated images in repeated loops.

In yet another aspect, a system for viewing real time traffic video on a handheld device is shown and described. The system comprises an appliance that resides in a traffic management center, extracts selected frames from a video stream of a remote traffic camera, codes the extracted group of images to produce coded image data and transmits the coded image data to a host server. The host server communicates with the appliance to receive and store the coded image data. The host server transmits the coded image data to a handheld device on receiving a request from the handheld device. The system further includes an application on the handheld device that allows a user to request real time traffic data through a menu driven interface, receives coded image data from the host server, decodes the image data to produce a group of concatenated images and displays the group of images on the handheld device in repeated loops.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is an embodiment of a system for delivering real-time traffic video to a handheld device;

FIG. 2 is an embodiment of a wireless network useful in connection with the methods and systems described herein;

FIG. 3 is a block diagram depicting an embodiment of a wireless handheld device;

FIG. 4 is a flow diagram depicting one embodiment of the steps taken at a handheld device to view real time traffic video;

FIG. 5 is a flow diagram depicting one embodiment of the steps taken at a host server to view real time traffic video on a handheld device; and

FIG. 6 is a collection of different embodiments of screenshots pertaining to an application program for delivering real-time traffic video to a handheld device.

### DETAILED DESCRIPTION OF THE INVENTION

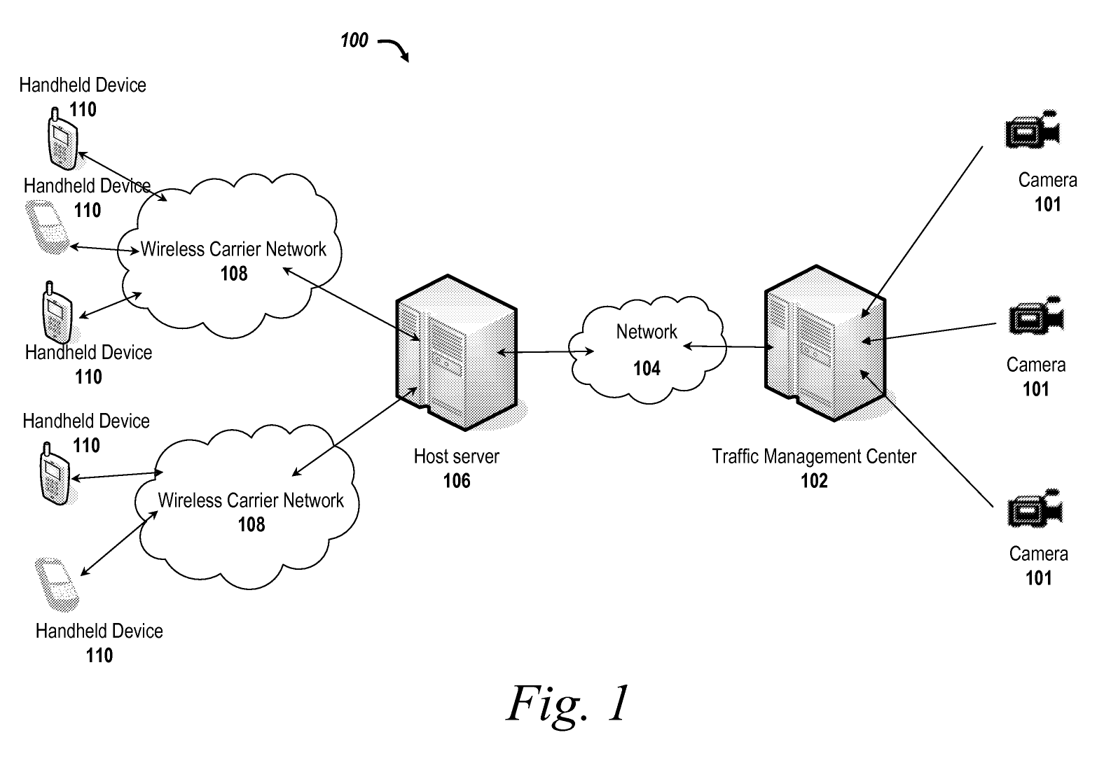

Referring to FIG. 1, an embodiment of a system delivering real-time traffic video to handheld devices is depicted. In brief overview, the system comprises a plurality of cameras 101 in various locations on a road network, a traffic management center (TMC) 102, a host server 106 and a plurality of handheld devices 110. The TMC 102 communicates with the host server 106 over a network 104. The host server 106 communicates with the handheld devices 110 over wireless carrier networks 108.

In one embodiment, the traffic cameras 101 are mounted at a plurality of locations along highways. In another embodiment, the cameras 101 are placed along with traffic lights on arterial roads. In still another embodiment, the cameras 101 are mounted on toll booths in order to monitor the extent of traffic backup. In yet another embodiment, the cameras 101 may be mounted on mobile entities such as a helicopter or a surveillance vehicle.

In some embodiments, the cameras 101 are closed circuit TV (CCTV) cameras. In one of these embodiments, the cameras 101 are connected to each other and the TMC 102 over an optical fiber network. In another of these embodiments, the cameras 101 may be connected to each other and the TMC 102 over a wireless network. In yet other embodiments, the cameras 101 maybe connected to each other and the TMC 102 over any other form of network apparent to one skilled in the art.

In one embodiment, the TMC 102 comprises a centralized server managing data from a plurality of sources including traffic cameras, loop detectors, radar detectors, toll booth cameras, ramp meters and emergency management vehicles and devices. In another embodiment, the TMC 102 is an appliance in an intelligent transportation system (ITS), where information about the transportation network is collected and combined with other operational and control data to manage the transportation.

In some embodiments, the TMC 102 may include multiple, logically-grouped servers. In one of these embodiments, the logical group of servers may be referred to as a server farm 103 (not shown). In another of these embodiments, the servers may be geographically dispersed. In one embodiment, a farm may be administered as a single entity. In another embodiment, the server farm 103 comprises a plurality of server farms 103.

In one embodiment, the TMC 102 includes an appliance 102′ (not shown) that creates a group of images from a stream of traffic video obtained from a camera 101. In one embodiment, the appliance 102′ is a software program running on a server at the TMC 102. In another embodiment, the appliance 102′ is a hardware unit residing at the TMC 102. In one embodiment, the appliance 102′ includes a storage database where the group of images is stored temporarily.

Although FIG. 1 shows a network 104 between the TMC 102 and the host server 106, the cameras 101 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the TMC 102 and the host server 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 and network topology may be of any such network or network topology as known to those ordinarily skilled in the art capable of supporting the operations described herein.

The host server 106 may be a file server, application server, web server, proxy server, appliance, network appliance, gateway, application gateway, gateway server, virtualization server, deployment server, secure socket layer (SSL) virtual private network (VPN) server, or firewall. In some embodiments, the host server comprises one or more databases.

In one embodiment, the host server 106 exists as a single entity. In another embodiment, multiple host servers 106 can be logically grouped in a server farm 103′ (not shown). The servers 106 within each farm 103′ can be heterogeneous. One or more of the servers 106 can operate according to one type of operating system platform (e.g., WINDOWS NT, manufactured by Microsoft Corp. of Redmond, Wash.), while one or more of the other servers 106 can operate on another type of operating system platform (e.g., Unix or Linux).

The servers 106 of each farm 103′ do not need to be physically proximate to another server 106 in the same farm 103′. Thus, the group of servers 106 logically grouped as a farm 103′ may be interconnected using a local area network (LAN) connection, a wide-area network (WAN) connection or a metropolitan-area network (MAN) connection.

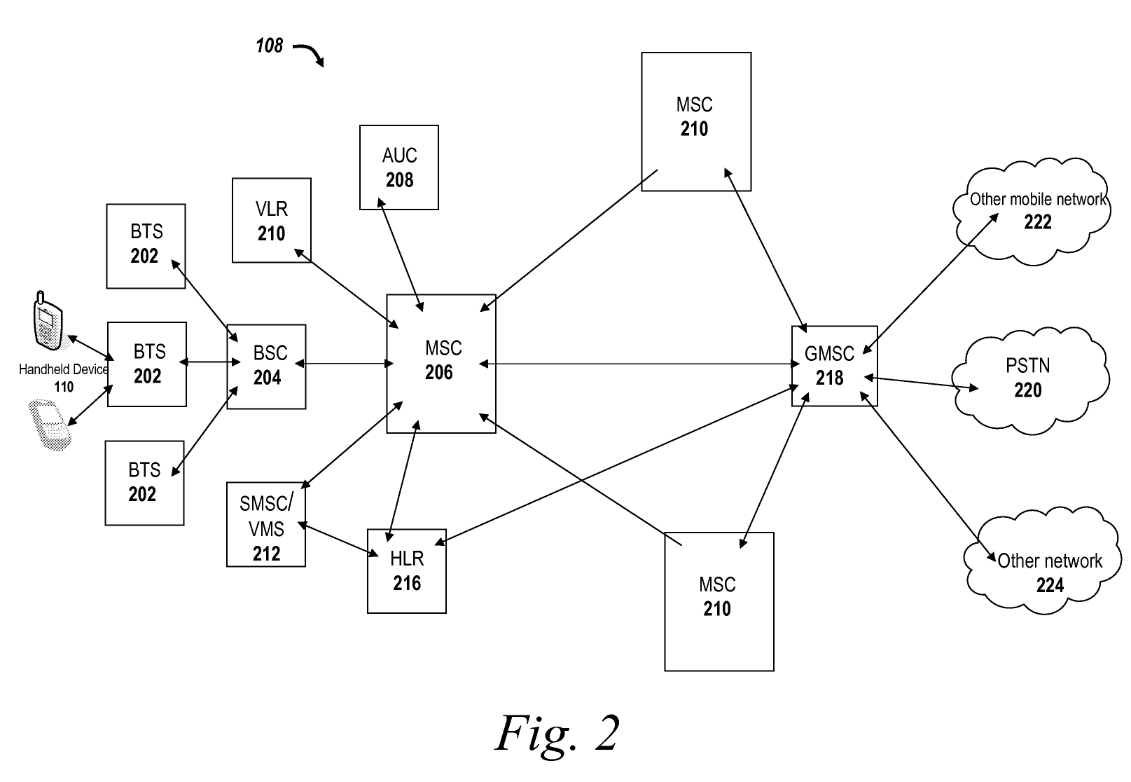

The host server 106 communicates with the handheld devices 110 via a wireless carrier network 108. The wireless carrier network 108, as used herein, refers to facilities operated by a commercial wireless service provider for the purposes of providing public telecommunication services. Various embodiments of the wireless carrier network 108 are described in more details below with reference to FIG. 2.

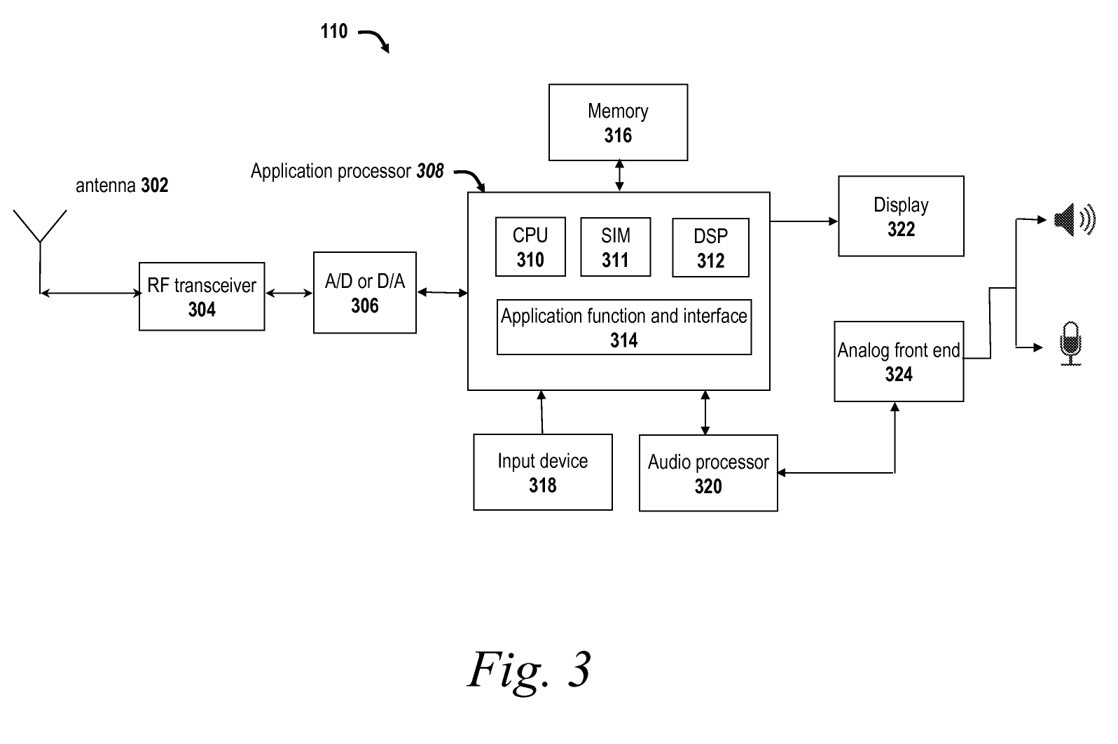

The wireless carrier networks 108 terminate in handheld devices 110. In one embodiment, the handheld device 110 is a cellular phone. In another embodiment, the handheld device 110 is a BLACKBERRY device manufactured by Research in Motion (RIM) of Waterloo, Ontario, Canada. In still another embodiment, the handheld device 110 is a personal digital assistant (PDA) phone or smartphone such as one manufactured by Palm Inc. of Sunnyvale, Calif. In yet another embodiment, the handheld device 110 is an IPHONE manufactured by Apple Inc. of Cupertino, Calif. In some embodiments, the handheld devices 110 support special software applications operating on various operating systems. In one of these embodiments, the handheld device 110 is JAVA enabled. In another of these embodiments, the handheld device 110 is Binary Runtime Environment for Wireless (BREW) enabled. In still another of these embodiments, the handheld device 110 is a Symbian handset. The handheld device 110 is described in more details below with reference to FIG. 3.

Referring now to FIG. 2, an embodiment of a wireless carrier network is shown. A wireless carrier network may comprise one or more, any or all of the following: base transceiver stations (BTS) 202 that communicate with the handheld devices 110, base station controllers (BSC) 204, mobile switching centers (MSC) 206, authentication center (AUC) 208, visitor location register (VLR) 210, short messaging service center (SMSC) and voice messaging center (VMC) 212, home location registers (HLR) 214 and gateway mobile switching centers (GMSC) 216. In one embodiment, the wireless carrier network 108 is connected to a public switched telecommunication network (PSTN) 218. In other embodiments, the wireless carrier network 108 is connected to some other mobile network 22 or some other network 224. In one of these embodiments, the wireless carrier network 108 is connected to the host server 106 as shown in FIG. 1.

The BTS 202 is an equipment that serves as an interface between the handheld devices 110 and the rest of the wireless carrier network 108. In one embodiment, the BTS 202 comprises an antenna for sending and receiving signals. In another embodiment, the BTS comprises a duplexer to separate outbound and inbound signals to and from the antenna, respectively. In still another embodiment, the BTS 202 may comprise an equipment for encrypting and decrypting communications. In yet another embodiment, the BTS comprises spectrum filtering tools such as bandpass filters.

The BTS 202 is controlled by the BSC 204. In one embodiment, a plurality of BTS 202 may be connected to a BSC 204. In one embodiment, the BSC 204 controls the BTS 202 via an intermediary Base Station Control Function (BCF) unit. In some embodiments, the BSC performs a plurality of tasks including allocation of radio channels to handheld devices 110, paging and quality management of transmission and reception.

The MSC 206 is a telephone exchange that provides a plurality of services including voice, data and fax services. In some embodiments, a plurality of BSC 204 are connected to a MSC 206. In one of these embodiments, the MSC 206 arranges handovers from one BSC 204 to another BSC 204. In another of these embodiments, the MSC 206 supports supplementary services including conference calls and call holding. In still another of these embodiment, the MSC 206 delivers calls and data to handheld devices 110 based on information obtained from the VLR 210. In yet another of these embodiments, the MSC 206 delivers short messages and voice messages to the SMSC/VMS 212. In one embodiment, the MSC 206 communicates with the AUC 208 to autheticate a handheld device attempting to access the wireless carrier network 108.

The HLR 214 is a centralized database that stores information about the handheld devices authorized to access the wireless carrier network 108. In one embodiment, the HLR 214 is a single database storing information about all the handheld devices authorized to access the network. In another embodiment, the HLR 214 may be a distributed database. In one embodiment, the HLR 214 communicates with the GMSC 218 to provide routing information to incoming calls. In another embodiment, the HLR 214 communicates with the SMSC/VMS 212 to handle delivery of SMS and voice message notifications to handheld devices 110.

The MSC 206 that interfaces with the PSTN 220 is termed as the GMSC 218. In one embodiment, all incoming and outgoing calls and data between one handheld device 110 and another handheld device 110 are routed through the GMSC 218. In another embodiment, all incoming and outgoing calls and data between a handheld device 110 and the PSTN 220 are routed through the GMSC 218.

In one embodiment, the wireless carrier network 108 can be a GSM/GPRS network. A person skilled in the art would appreciate that the claimed invention may be deployed in alternative networks bearing different bearers, protocols, technologies, architectures and topologies. In other embodiments, the wireless carrier network 108 may comprise one or more of the following: Universal Mobile Telecommunications Service (UMTS), Code Division Multiple Access (CDMA) including CDMA2000 1x, CDMA2000 1xEV-DO, CDMA2000 1xEV-DV, CDMA TIA/EIA/ANSI-95A/B), GPRS, Enhanced Data rates for GSM Evolution (EDGE), Wideband Code Division Multiple Access (W-CDMA), Personal Digital Cellular (PDC), Integrated Digital Enhanced Network (iDEN), High-Speed Uplink Packet Access (HSUPA) UMTS, High Speed Downlink Packet Access (HSDPA) UMTS, Freedom of Mobile Multimedia Access (FOMA), Time Division-Synchronous Code Division Multiple Access (TD-SCDMA), Time Division-Code Division Multiple Access (TD-CDMA), UMTS-Time division duplexing (UMTS-TDD), UMTS Long Term Evolution (LTE), Frequency division multiplexing (FDM), Frequency division duplexing (FDD), Direct Sequence Ultra wide band (DS-UWB), Internet Protocol multimedia Subsystem (IMS), Session Initiation Protocol (SIP), Orthogonal Frequency Division Multiple (OFDM), Orthogonal Frequency Division Multiple Access (OFDMA), Software-defined radio (SDR), Personal Communications Service (PCS), High-Speed Circuit-Switched Data (HSCSD), Ultra Wideband (UWB), Wideband Integrated Dispatch Enhanced Network (WiDEN), Unlicensed Mobile Access (UMA), WiMax IEEE 802.16, WiFi IEEE 802.11, Wireless Local Area Network (WLAN), Circuit Switched Data (CSD), wireless wide-area network (WWAN), Voice over Internet Protocol (VOIP), time division multiple access (TDMA), Wireless Broadband (WiBro), Time Division CDMA (TD-CDMA), Voice over WLAN (VoWLAN), Multiple-input multiple-output (MIMO), Variable-Spreading-factor Spread Orthogonal Frequency Division Multiplexing, Push to Talk (PTT), Signaling System 7 (SS7), SS7 over IP, Message Transfer Part-Level 2 Peer-to-Peer Adaptation Layer (M2PA), Message Transfer Part—Level 3 User Adaptation Layer (M3UA), Common Channel Signaling System 7 (CCS7), Transmission Control Protocol/Internet Protocol (TCP/IP), Hyper Text Transfer Protocol (HTTP), Hyper Text Transfer Protocol Secure (HTTPS), User Datagram Protocol (UDP).

Referring now to FIG. 3, a block diagram depicting one embodiment of a handheld device 100 is shown. In brief overview, the handheld device 110 comprises one or more of the following: a radio transceiver 304, a unit containing an analog to digital and a digital to analog converter 306, an application processor 308, memory 316, input devices such as keypads, thumbwheels or touchscreens 318, an audio processor 320, a display device 322 and an analog front end 324 comprising a mouthpiece and speakers. In one embodiment, the application processor 308 comprises a central processing unit (CPU) 310 and a digital signal processor (DSP) 312. In some embodiments, the application processor 308 further comprises application functions and interfaces 314. In one of these embodiments, the application functions and interface 314 includes an application program 315 (not shown) to view real time traffic video on the handheld device.

In one embodiment, the handheld device may comprise a subscriber identification module (SIM) 311. The SIM 311 is used to store unique subscription and authentication information about the user of the handheld device, the network that the SIM 311 has permission to connect to and the services that the SIM 311 may access on the network. In some embodiments, the SIM 311 stores an address book of telephone numbers. A SIM 311 may comprise one or more application programs employing SIM Application Toolkit (SAT) technology or other smart card application technologies.

In another embodiment, the handheld device 110 may comprise a Universal Integrated Circuit Card (UICC) in place of a SIM 311. A UICC may comprise one or more Identity Module (IM) technologies of: GSM Subscriber Identity Module (SIM), UMTS Internet Protocol Multimedia Services Identity Module (ISIM), CDMA Removable User Identity Module (R-UIM), plus value added applications. The UICC applications may use one or more technologies of: Universal SIM Application Toolkit (USAT), CDMA Card Application Toolkit (CCAT), Card Application Toolkit (CAT), UIM Application Toolkit (UATK) or other smart card technologies.

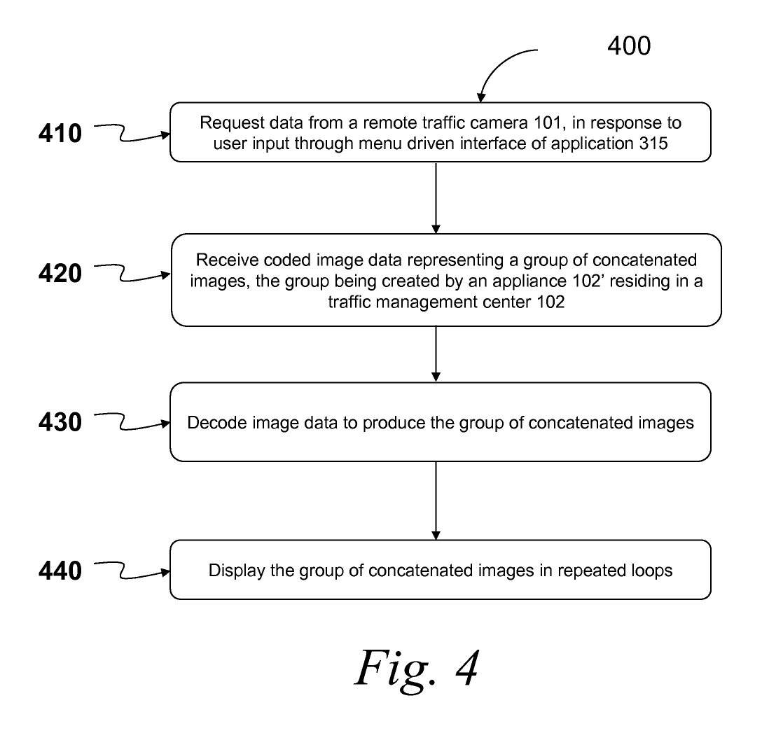

Now referring to FIG. 4, a flow diagram depicting one embodiment, of the steps taken at a handheld device 110 to display real-time traffic video is shown. In brief overview, the handheld device 110 requests (step 410) data from a remote traffic camera responsive to input provided by a user through the menu driven interface of an application program 315 (not shown). The handheld device receives (step 420) coded image data representing a group of concatenated images. In one embodiment, the group is created at the traffic management center 102 by the appliance 102′. The coded data is decoded (step 430) at the handheld device by the application program 315. The group of images is then displayed (step 440) on the display unit 322 of the handheld device 110.

In some embodiments, the application program 315 of step 410 is downloaded on the handheld device 110 based on a subscription. In one of these embodiments, the subscription is provided by a wireless carrier. In another of these embodiments, the subscription can be obtained through a web banner on the Internet. In still another of these embodiments, the subscription may be obtained by calling a phone number advertised through other advertising media including TV, radio, print and billboard. In these embodiments, the application program 315 is delivered to the handset 110 based on the subscription information. In one embodiment, a SMS is sent to the handheld device 110 containing an embedded link to a wireless access protocol (WAP) site where the application may be downloaded from. The application 315 and the user interface of the application 315 are optimized for different handsets. In one embodiment, the handset type is auto-sensed responsive to the user following the embedded link. In another embodiment, the user is prompted to enter the information about the handset. In one embodiment, a compatible and optimized application program 315 is delivered and installed on the handset 110 responsive to determining the handset type.

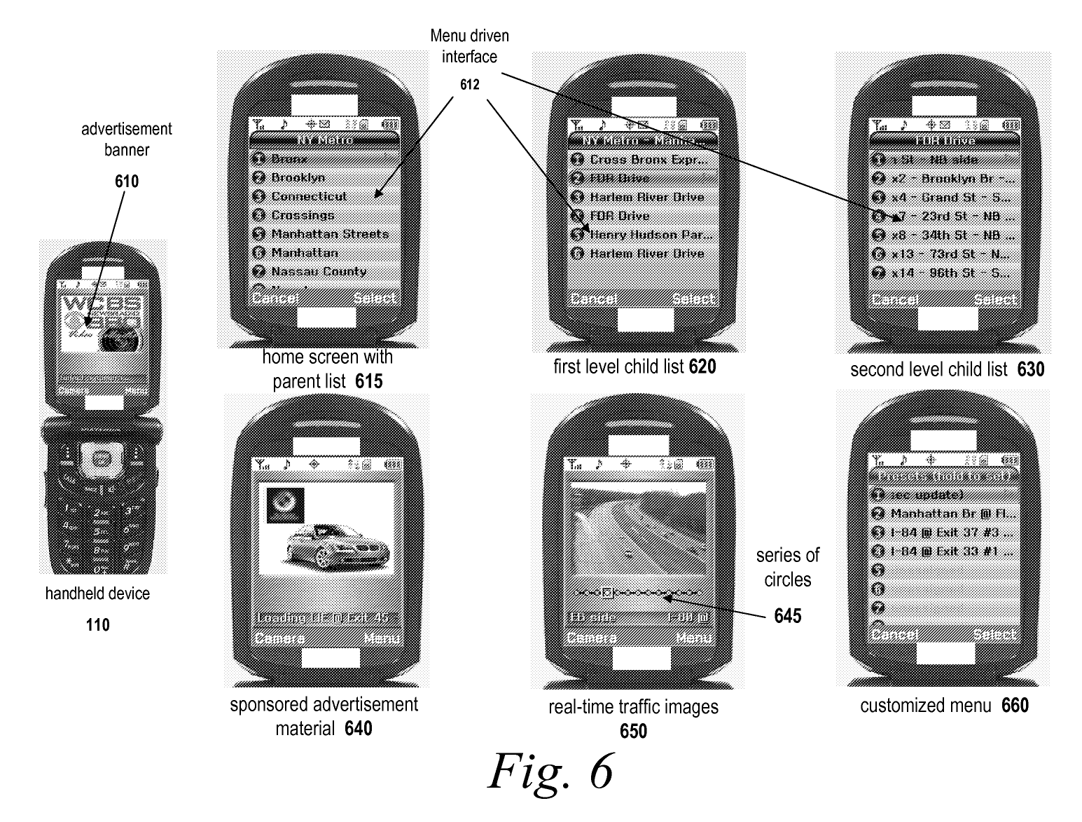

In other embodiments, downloading the application program 315 does not require the subscription. Referring now to FIG. 6, in some of these embodiments, sponsored advertisement material 640 is displayed when real time traffic video is requested by the user. In one of these embodiments, the advertisement material 640 is delivered and displayed on the handheld device 110 prior to displaying the requested traffic images 650. In another of these embodiments, the advertisement material 640 is preloaded into the handheld device 110 and displayed during buffering of the requested images 650 in the handheld device 110. In still another of these embodiments, the advertisement material 640 preloaded in the handheld device 110 is refreshed intermittently. In yet another of these embodiments, content of the advertisement material 640 preloaded in the handheld device 110 is determined by the location and pattern of use of the user. In one embodiment, the content of the advertisement material 640 is determined by an agent, in communication with the wireless carrier network 108.

Further elaborating on step 410 and still referring to FIG. 6, in one embodiment, data from a remote traffic camera may be requested through a menu driven interface 612 of the application program 315. In one embodiment, a home screen 615 of the menu driven interface 612 is displayed responsive to the user launching the application 315 on the handheld device 110. In another embodiment, a sponsored advertisement banner 610 is displayed on the handheld device 110 prior to displaying the home screen 615.

In one embodiment, the home screen 615 of the menu displays a parent list of current areas where the traffic cameras 101 are available. In one embodiment, a first level child list 620 showing the roads on which the cameras 101 are available, is displayed responsive to the user selecting an area from the parent list on the home screen 615. In another embodiment, a second level child list 630 showing the intersections at which the cameras 101 are available, is displayed responsive to the user selecting a road from the first child list 620. In other embodiments, the menu may be divided and subdivided in a plurality of other ways apparent to one ordinarily skilled in the art.

In one embodiment, the location of the camera 101 may be chosen through interactive maps displayed on a screen of the handheld device 110. In another embodiment, the user can create a customized menu 660 assigning keys from a keypad on the handheld device to favorite cameras.

In one embodiment, the entire menu structure is loaded in the memory of the handheld device when the application program 315 is launched. In another embodiment, only the parent list 615 and the first level child list 620 are loaded when the application program 315 is launched. In this embodiment, the subsequent levels of lists are loaded as needed. In some embodiments, the lists are swapped in and out of the system 100 to remove disabled or non-functional cameras from the lists.

In one embodiment, the application program 315 runs on a Java platform such as J2ME and JavaFX developed by Sun Microsystems of Santa Clara, Calif. In another embodiment, the application program 315 runs on an embedded Linux platform such as Mobilinux developed by Monta Vista Software of Santa Clara, Calif. In still another embodiment, the application program 315 runs on Windows Mobile operating system developed by Microsoft Corporation of Redmond, Wash. In yet another embodiment, the application program runs on Palm OS developed by Palm Inc. of Sunnyvale Calif. In some other embodiments, the application program 315 runs on other proprietary and non-proprietary operating systems including Blackberry OS developed by Research In Motion of Waterloo, Ontario, Canada, Binary Runtime Environment for Wireless (BREW) developed by Qualcomm Inc. of San Diego, Calif. and Symbian OS developed by Symbian Ltd. of Southwark, UK.

Referring now to step 420, the coded image data representing a group of concatenated images is received by the handheld device from the host server 106 through a wireless carrier network 108. The wireless carrier network 108 is as described with reference to FIG. 1. In one embodiment, the host server 106 authenticates the handheld device 110 to verify subscription information prior to transmitting the requested data to the handheld device 110.

In one embodiment, the coded image data received in step 420 is compressed and coded by an appliance 102′ residing in the TMC 102. In some embodiments, the appliance 102′ converts real-time traffic video images from a camera 101 into an encoded format suitable for transmitting to and displaying on a handheld device 110. In one of these embodiments, the video images from the camera 101 may be of an analog or digital format including: NTSC, PAL, SECAM, CCIR, RS-170, MPEG, MPEG-2, MPEG-4, D1, D2 and H.264. In some embodiments, the process of converting the real-time video into the encoded format includes extracting, by the appliance 102′, selected frames from the video and compressing the selected frames using a data compression technique. In some other embodiments, the data compression technique may include one or more of the following: run-length coding, entropy coding, adaptive algorithms, deflation, reduction of color space, chroma sub-sampling, transform coding, fractal compression, difference coding, discrete cosine transform, discrete wavelet transform, discrete Fourier transform and other commonly used compression techniques apparent to one ordinarily skilled in the art. In one embodiment, a plurality of selected frames may be combined into a composite frame before applying the compression technique.

The coded image data is decoded (step 430) at the handheld device 110 by the application program 315. The decoding involves using an operation corresponding to the compression technique used in step 420 such that the group of images is recovered from the coded image data.

In step 440, the decoded group of images is displayed on the screen of the handheld device 110. In one embodiment, the images of a first group of images are shown sequentially in repeated loops until a second group of images is received and decoded. In another embodiment, the images from the first group of images are shown sequentially in repeated loops until the user presses a key or selects a menu item indicating that the second group of images should be requested. In still another embodiment, the user may choose to receive the second group of images automatically rather than by manual request.

Referring again to FIG. 6, in some embodiments, a series of circles 645 are displayed at the bottom of the screen while a group of real-time traffic images 650 from a first camera is being displayed on the screen of the handheld device 110. In one of these embodiments, the circles 645 represent other cameras 101 placed at a plurality of different locations on the road on which the first camera is located. In another of these embodiments, a filled circle among the group of circles 645 represents the camera, from which images are being displayed. In still another of these embodiments, a camera different from the first camera may be selected by selecting a different circle displayed at the bottom of the screen. In some other embodiments, the series of circles 645 may be displayed in any part of the screen of the handheld device 101. In yet other embodiments, the different cameras 101 may be represented by any other symbols, icons or alphanumeric characters apparent to one ordinarily skilled in the art.

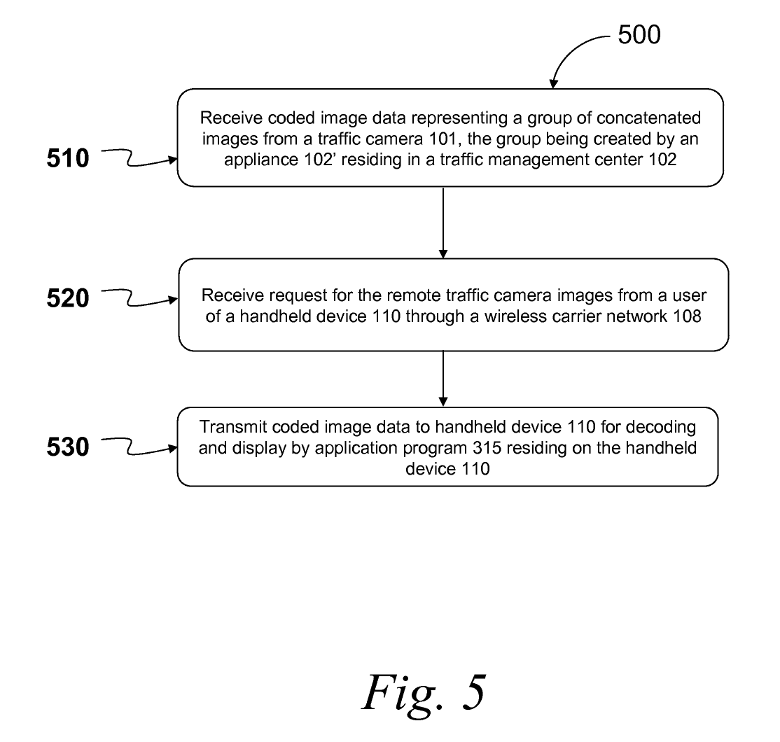

Now referring to FIG. 5, a flow diagram depicting one embodiment of the steps taken at a host server 106 to deliver real time traffic video to a handheld device 110 is shown. In brief overview the method includes receiving (step 510), by the host server 106, coded image data representing a group of concatenated images captured by a remote traffic camera 101. In one embodiment, the group of concatenated images is converted to coded image data by an appliance 102′ residing in a traffic management center (TMC) 102. Detailed description of the appliance 102′ and TMC 102 are given with reference to FIG. 1 and FIG. 4. The method further includes receiving (step 520), at the host server, request for remote traffic camera images from a user of a handheld device 110 through a wireless carrier network 108 and transmitting (step 530), by the host server, coded image data to the handheld device 110 for decoding and display by an application program residing on the handheld device 110. Further details about the handheld device 110, the wireless carrier network 108 and the host server 106 are given with reference to FIG. 1 and FIG. 4.

Having described certain embodiments of methods and systems for delivering real-time traffic video to a handheld device, it will now become apparent to one of skill in the art that other embodiments incorporating the concepts of the invention may be used. Therefore, the invention should not be limited to certain embodiments, but rather should be limited only by the spirit and scope of the following claims.

What is claimed is:

1. A method of viewing real-time traffic images on a handheld device, the method comprising:
requesting, by a handheld device, data from a remote traffic camera responsive to input provided by a user through a menu-driven interface of an application program;
receiving, by the handheld device, coded image data representing a first group of concatenated still images, the first group being created by an appliance residing in a traffic management center, the appliance creating the first group by extracting selected frames from a video stream of a remote traffic camera;
decoding the coded image data to produce the first group of concatenated still images; and
displaying, on the handheld device, the first group of concatenated images in repeated loops until coded image data representing a second group of images is decoded.

2. The method of claim 1 further comprising receiving and installing, by the handheld device, the application program from a remote location.

3. The method of claim 1 further comprising displaying on the handheld device, sponsored advertisement information, responsive to the handheld device requesting data from the remote traffic camera.

4. The method of claim 1 further comprising preloading in the cache of the handheld device, the sponsored advertisement information.

5. The method of claim 1 further comprising determining, by an agent, content of the sponsored advertisement information, based on location and pattern of use of the user of the handheld device.

6. The method of claim 1 wherein the handheld device is chosen from a group comprising a mobile phone, a BLACKBERRY device, an IPHONE device, a personal digital assistant (PDA) and a smartphone.

7. The method of claim 1 further comprising the handheld device and a host server communicating with one another via one or more wireless carrier networks.

8. The method of claim 1 further comprising the user choosing to receive the second group of images automatically rather than manually requesting the second group of images.

9. A method of displaying real time traffic data on a handheld device, the method comprising:
receiving, by a host server, coded image data of real-time traffic, the coded image data representing a group of concatenated still images created by an appliance residing in a traffic management center, the appliance creating the group by extracting selected frames from a remote traffic camera video stream;
receiving, by the host server via a wireless carrier server, a request for data from the remote traffic camera responsive to input provided by a user through a menu-driven interface of an application program executing on a handheld device; and
transmitting, by the host server, responsive to receiving the request, the coded image data to the handheld device, the handheld device decoding the coded image data and displaying the resulting group of concatenated still images in repeated loops.

10. The method of claim 9 further comprising authenticating, by the host server, the handheld device responsive to receiving the request for data from the remote traffic camera.

11. The method of claim 9 further comprising the host server and the handheld device communicating with one another via one or more wireless carrier networks.

12. The method of claim 9 further comprising transmitting, by the host server, sponsored advertisement information to the handheld device, responsive to the handheld device requesting data from the remote traffic camera.

13. The method of claim 9 further comprising the host server communicating with an agent to determine content of the sponsored advertisement information to be transmitted to the handheld device.

14. A system of displaying real-time traffic information on a handheld device, the system comprising:
an appliance residing in a traffic management center, the appliance extracting selected frames from a video stream of a remote traffic camera, coding the extracted frames to produce first coded image data, and transmitting the first coded image data;
a host server in communication with the appliance, receiving and storing the first coded image data and transmitting the first coded image data responsive to receiving a request from a handheld device;
an application on the handheld device in communication with the host server through a wireless carrier server, the application requesting real-time traffic data from a remote traffic camera responsive to input provided by a user through a menu-driven interface, receiving the first coded image from the server, decoding the first coded image data to produce a group of concatenated still images and displaying the group of concatenated still images in repeated loops until second coded image data representing a second group of images is decoded.

14. The system of claim 14 wherein the appliance residing in the traffic management center is a codec.

15. The system of claim 14 wherein the host server comprises one or more of a file server, an application server, a web server, a proxy server, an appliance, a gateway, a gateway server, a virtualization server, a deployment server, a secure socket layer (SSL) virtual private network (VPN) server, a database or a firewall.

16. The system of claim 14 wherein the handheld device is chosen from a group comprising a mobile phone, a BLACKBERRY device, an IPHONE device, a personal digital assistant (PDA) and a smartphone.

17. The system of claim 14 wherein the application program is received and installed in the handheld device from a remote location.

18. The system of claim 14 wherein the application program runs on a platform chosen from a group consisting of J2ME, JavaFX, Palm OS, BlackBerry OS, Microsoft Windows Mobile, Binary Runtime Environment for Wireless (BREW), Symbian OS, Embedded Linux and Mobilinux.

19. The system of claim 14 wherein the user chooses to receive the second group of images automatically rather than manually requesting the second group of images.
